(19) United States
(12) Patent Application Publication
(10) Pub. No.: US 2004/0219906 A1
(43) Pub. Date: Nov. 4, 2004

(54) Wireless verbal announcing method and system

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/428,299

(22) Filed: May 2, 2003

(51) Int. Cl. H04M 3/42

(52) U.S. Cl. 455/415; 455/414.1

(57) ABSTRACT

A method and system in a telecommunications network for verbally announcing an incoming call has in one embodiment the steps of: receiving from a telecommunications network indication of a call with caller-ID information at a mobile phone; determining at the telecommunications network, for a given caller, if unique audio information has been stored for the caller-ID information; using text-to-speech translated external database lookup information for the name and number that is associated with the caller-ID information, if no unique audio information has been stored for the caller-ID information; transmitting, from the telecommunications network to the mobile phone, the audio information that is associated with the caller-ID information; and playing the audio information at the mobile phone. The system implements the method.

### TECHNICAL FIELD

The present invention relates to wireless telephony in general, and, more particularly, to a method and system for verbally announcing a caller identity on a mobile phone.

### BACKGROUND OF THE INVENTION

Wireless telephones, which include both cellular telephones and the higher frequency personal communication devices (PCDs), are growing in numbers and also shrinking in size and weight. The growth in numbers is influenced by the convenience and the per call cost of wireless telephones with respect to pagers and wire line telephones or coin telephones for completing calls, especially when the user is away from home or office. The shrinking size is influenced by two related technologies: more efficient receive/transmit processing circuits and higher power density batteries.

Telephone service subscribers do not necessarily want to answer all the telephone calls they receive. However, in order to know what calls they are interested in answering, subscribers must know who is calling. Presently available systems display, on a special display device associated with a subscriber's telephone, the caller's phone number and billing name of the caller. This special display device is available integrated with a telephone in a single telephonic unit or as a device connected separately to an existing telephone.

The name of the person or entity associated with the phone number can be found by a reverse directory lookup of the number in the telephone company's billing information. On some present systems, the name and/or number of the caller can be displayed on the subscriber's display device. In cases where the caller name is displayed, the names that can be displayed are limited to those that are serviced by the same telephone company as the subscriber. The visual display approach uses a data modem signal that is transmitted by the central office on the subscriber's line between the first and second ring. This necessitates a modem to encode the data at the subscriber's central office Service Switching Point and a modem built-in with the display logic at the subscriber's receiving location. However, there are many situations, such as, driving a vehicle, when a user desires to know the identity of a caller without looking at the display on a mobile phone. Also, even on a non-mobile the user may prefer not to have to look at a display to identify the caller for an incoming call.

However, it is a drawback of the prior art that the providing of audio call ID information is limited to information stored in the telecommunications network, or in the user's equipment. Thus, there is a need in the art for an improved method and system for verbally announcing a caller identity on a mobile phone.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present method and system to provide a method and system for verbally announcing a caller identity on a telephone.

It is another aspect of the present method and system to provide a verbal announcing method and system utilized in a telecommunications network.

It is yet another aspect of the present method and system to provide a verbal announcing device for alerting a user to incoming calls and/or messages within the context of a telecommunications network.

It is still a further aspect of the present method and system to provide a verbal announcing device that is associated with a user and/or a mobile station (e.g., a cellular telephone) within a telecommunications network.

In general, the present method and system in a telecommunications network is for verbal announcing a user of an incoming call.

In general terms the method in a telecommunications network is for verbally announcing a caller identity on a mobile phone. In one embodiment the method has the steps of: receiving from a telecommunications network indication of a call with caller-ID information; determining at the telecommunications network, for a given caller, if unique audio information has been stored for the caller-ID information; using text-to-speech translated external database lookup information for the audio information that is associated with the caller-ID information if unique audio information has been stored for the caller-ID information; using generic audio information for the audio information that is associated with the caller-ID information, if no unique audio information has been stored for the caller-ID information; transmitting, from the telecommunications network to the mobile phone, the audio information that is associated with the caller-ID information; and playing the audio information at the mobile phone.

Also, in general terms the system in a telecommunications network is for verbally announcing a caller identity on a mobile phone. The system has: a determination module at telecommunications network, that for a given call, selects one of at least two sources of audio information, and outputs a selected audio information for the caller-ID information; and an audio module in the mobile phone that plays the selected audio information at the mobile phone.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of a conventional mobile switching center, base station and mobile stations thereof for use with the present method and system.

FIG. 2 illustrates a block diagram illustrative of a mobile switching center, base station, mobile station and verbal announcing system according to one embodiment of the present method and system.

FIG. 3 illustrates a flow chart of logical operational steps that can be followed in accordance with one embodiment of the present method and system.

FIG. 4 illustrates a flow chart of logical operational steps that can be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

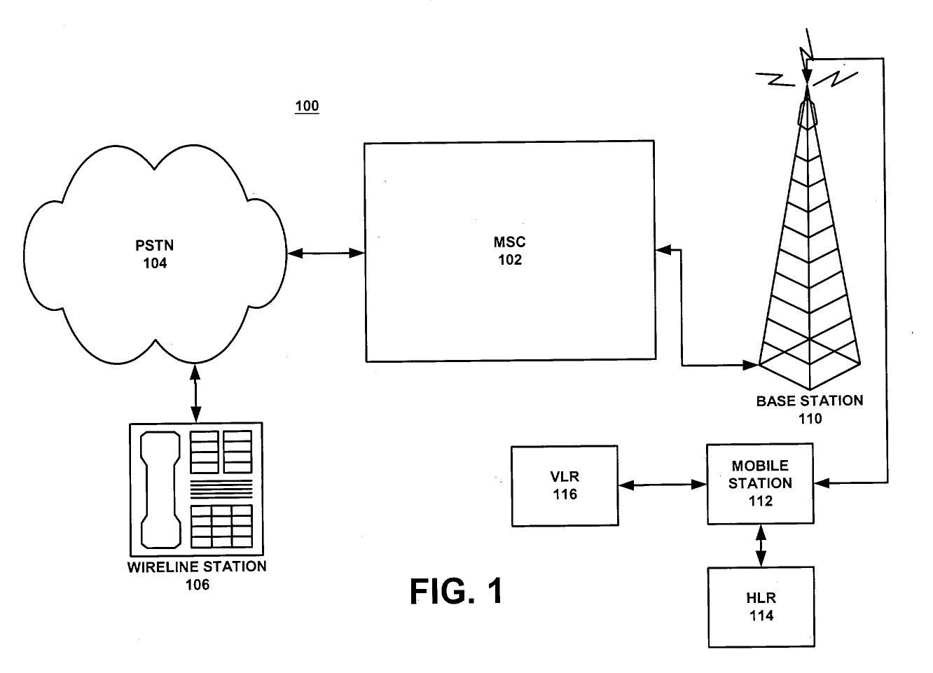

Referring to FIG. 1, a system 100 is depicted for verbally announcing an incoming call to mobile handsets (also referred to as mobile phones). System 100 has a mobile switching center (MSC) 102. A public switched telephone network (PSTN) 104 is connected to MSC 102. The PSTN 104 routes calls to and from mobile users through the MSC 102. The PSTN 104 also routes calls from and to wireline stations 106. MSC 102 is also connected to one or more base stations (BS) 110. Each of the base stations 110 communicates with mobile station(s) 112 in its service area. PSTN 104 generally can be implemented as the worldwide voice telephone network accessible to all those with telephones and access privileges (e.g., AT&T long distance network).

Each of the mobile stations 112 has a home location register (HLR) 114 where data about each of the mobile stations 112 resides. Some of the mobile stations 112 maybe remotely located from their home location, and in that case, a visiting location register (VLR) 116 is set up locally for each mobile station 112 that is visiting in its service area. HLR 114 can be implemented as a permanent SS7 database utilized in cellular networks, such as, but not limited to, for example, AMPS (Advanced Mobile Phone System), GSM (Global System for Mobile Communications), and PCS.

HLR 114 can be utilized generally to identify/verify a subscriber, and also contains subscriber data related to features and services. HLR 114 is generally utilized not only when a call is being made within a coverage area supported by a cellular provider of record, but also to verify the legitimacy and to support subscriber features when a subscriber is away from his or her home area. VLR 116, on the other hand, can be implemented as a local database maintained by the cellular provider whose territory is being roamed. Mobile station 112 can be implemented as a cellular device, personal communication device, short message service device or wireless communications device (e.g., a wireless personal digital assistant).

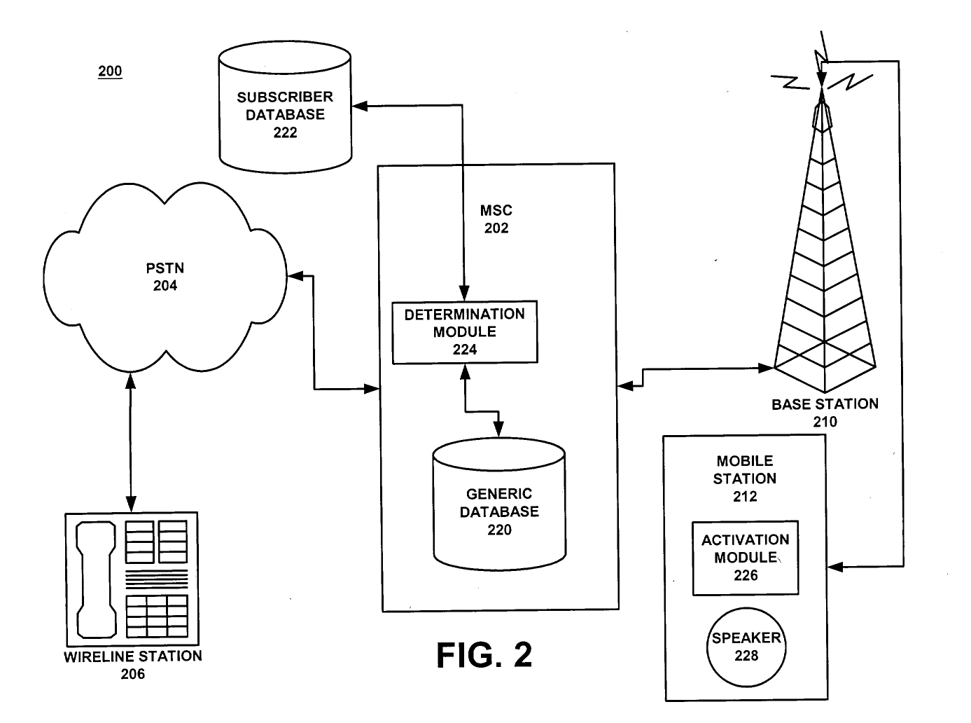

FIG. 2 illustrates a block diagram illustrative of a mobile switching center 202 operatively connected to at least two sources, 220 and 222, of audio information, a determination module 224, base station 210, and mobile station 212 according to one embodiment of the present method and system. Referring to FIG. 2, a system 200 for verbally announcing an incoming call for mobile handsets is shown. System 200 includes mobile switching center (MSC) 202. A public switched telephone network (PSTN) 204 is generally connected to MSC 202. PSTN 204 routes calls to and from mobile users through MSC 202, and routes calls from and to wireline stations 206. MSC 202 is connected to one or more base stations 210. The base station(s) 210 communicates through the air to mobile stations, which may be of a cellular telephone type or of the wider bandwidth personal communication device type. Mobile stations 212 are wireless handsets or automobile mounted stations the same as those shown in FIG. 1.

The determination module 224 at telecommunications network, for a given call, selects one of the at least two sources 220, 222 of audio information, such as a generic database 220 and subscriber database 222, and outputs a selected audio information for the caller-ID information. The first or subscriber database 222 is operatively connected to the telecommunications network and has at least one unique audio information that is respectively associated with at least one caller-ID information. The first database 222 is external to the telecommunications network and has at least one telephone number to name mapping for translation from text to speech. The second or generic database 220 at the telecommunications network has at least one generic audio information that is respectively associated with at least one further caller-ID information.

The mobile phone may have an activation module that activates and deactivates a capability of the mobile phone to utilize audio information that is associated with the caller-ID information. Also, the audio information that is associated with the caller-ID information in the subscriber's database 222 may be input from the mobile phone.

The telecommunications system also may ring the mobile phone when the audio information that is associated with the caller-ID information is transmitted to the mobile phone. In a typical embodiment the audio information may be played through a speaker 228, for example, of the mobile phone.

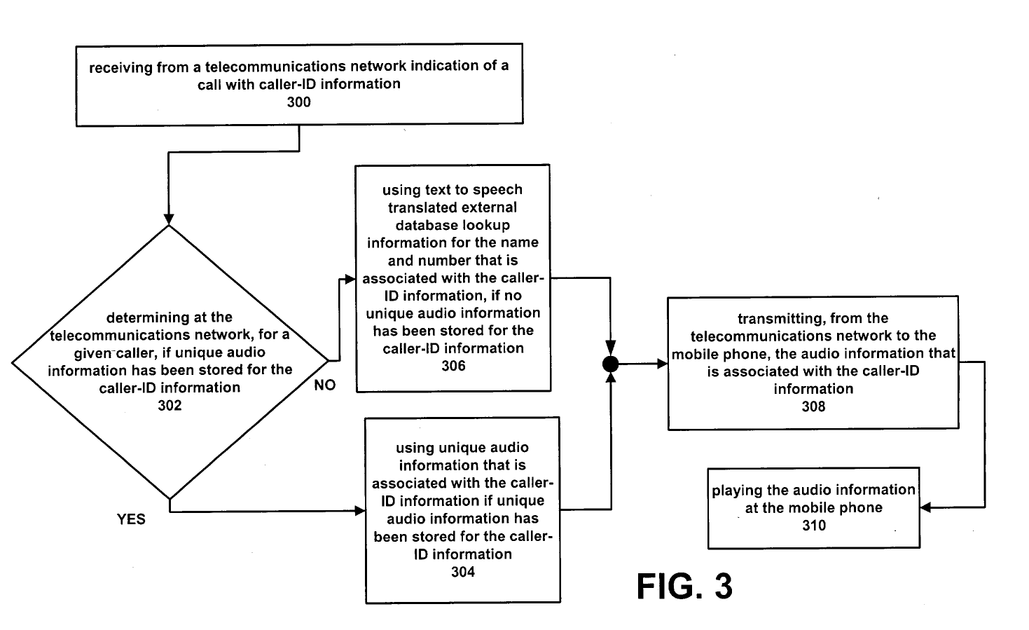

FIG. 3 is a block diagram depicting an embodiment of the present method. In this embodiment of the method in a telecommunications network for verbally announcing a caller identity on a telephone, the method may have the steps of: receiving from a telecommunications network indication of a call with caller-ID information (step 300); determining at the telecommunications network, for a given caller, if unique audio information has been stored for the caller-ID information (step 302); using unique audio information that is associated with the caller-ID information if unique audio information has been stored for the caller-ID information (step 304); using text-to-speech translated external database lookup information for the generic name and number that is associated with the caller-ID information, if no unique audio information has been stored for the caller-ID information (step 306); transmitting, from the telecommunications network to the mobile phone, the audio information that is associated with the caller-ID information (step 308); and playing the audio information at the mobile phone (step 310).

A text-to-speech synthesizer may be used in the form of a computer memory having text-to-speech software associated therewith. Alternatively, the text-to-speech synthesizer may be implemented fully in hardware, such as a digital signal processor. The text-to-speech synthesizer may be of a basic design capable of only converting textual data to speech signals representing numeric data, such as a telephone number, or a somewhat more advanced design capable of converting textual data to speech signals representing alphanumeric information, such as a calling party's name and telephone. The level of design of the text-to-speech synthesizer depends upon such engineering tradeoffs as power of the processor and complexity of the text-to-speech software.

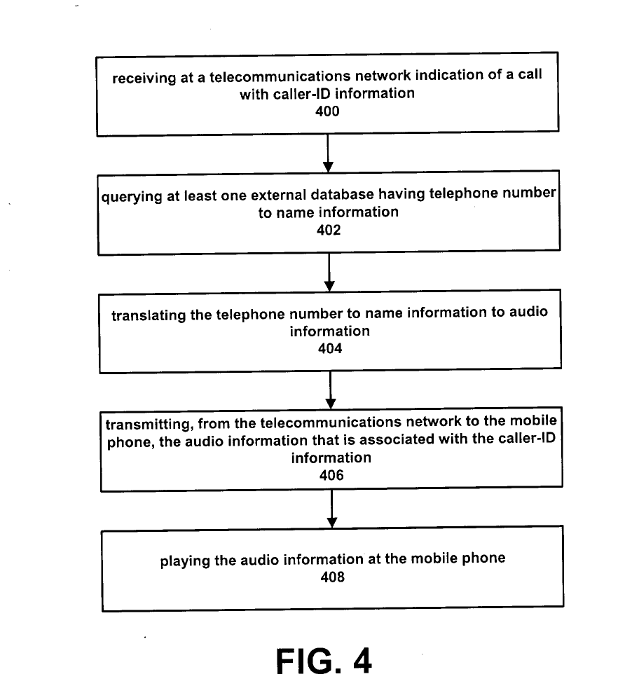

FIG. 4 is a block diagram depicting anther embodiment of the present method. In this embodiment of the method in a telecommunications network for verbally announcing a caller identity on a telephone, the method may have the steps of: receiving at a telecommunications network indication of a call with caller-ID information f (step 400); querying at least one external database having telephone number to name information (step 402); translating the telephone number to name information to audio information (step 404); transmitting, from the telecommunications network to the mobile phone, the audio information that is associated with the caller-ID information (step 406); and playing the audio information at the mobile phone (step 408).

The present system and method for verbally announcing an incoming call may be uses with non-mobile phones, as well as, mobile phones. Also, different types of data storage devices may be used with the present method and system. The present invention overcomes the drawbacks of the prior art and provides an improved method and system in a telecommunications network for verbally announcing a caller identity on a mobile phone.

The method and system of the present invention may be implemented in hardware, software, or combinations of hardware and software. In a software embodiment, portions of the present invention may be computer program products embedded in computer readable medium.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method in a telecommunications network for verbally announcing a caller identity on a telephone, said method comprising the steps of:
receiving from a telecommunications network indication of a call with caller-ID information;
querying at least one external database having telephone number to name information;
translating the telephone number to name information to audio information;
transmitting, from the telecommunications network to the mobile phone, the audio information that is associated with the caller-ID information; and
playing the audio information at the mobile phone.

2. The method of claim 1 further comprising the step of:
selecting one of turning on and turning off a capability of the mobile phone to utilize audio information that is associated with the caller-ID information.

3. The method of claim 2 further comprising the steps of:
determining if unique audio information has been stored for the caller-ID information;
using the unique audio information for the audio information that is associated with the caller-ID information if unique audio information has been stored for the caller-ID information; and
using text-to-speech translated external database lookup information for the audio information that is associated with the caller-ID information, if no unique audio information has been stored for the caller-ID information.

4. The method of claim 1 further comprising the steps of:
transmitting, from the mobile phone to the telecommunications network, at least one unique audio information that is respectively associated with at least one caller-ID information; and
storing at least one unique audio information that is respectively associated with at least one caller-ID information at the telecommunications network.

5. The method of claim 4 further comprising the steps of:
storing at least one unique audio information that is respectively associated with at least one caller-ID information in a first database at the telecommunications network; and
retrieving caller name information from a caller number lookup in an external database; and
translating to speech the caller name information.

6. The method of claim 4 further comprising the step of:
selecting one of turning on and turning off a capability of the mobile phone to utilize audio information that is associated with the caller-ID information.

7. A method in a telecommunications network for verbally announcing a caller identity on a mobile phone, said method comprising the steps of:
receiving from a telecommunications network indication of a call with caller-ID information;
determining at the telecommunications network, for a given caller, if unique audio information has been stored for the caller-ID information;
using text-to-speech translated external database lookup information for the audio information that is associated with the caller-ID information if unique audio information has not been stored for the caller-ID information;
using generic audio information for the audio information that is associated with the caller-ID information, if no unique audio information has been stored for the caller-ID information;
transmitting, from the telecommunications network to the mobile phone, the audio information that is associated with the caller-ID information; and
playing the audio information at the mobile phone.

8. The method of claim 7 further comprising the steps of:
transmitting, from the mobile phone to the telecommunications network, at least one unique audio information that is respectively associated with at least one caller-ID information; and
storing the at least one unique audio information that is respectively associated with at least one caller-ID information at the telecommunications network.

9. The method of claim 7 further comprising the steps of:
storing the at least one unique audio information that is respectively associated with at least one caller-ID information in a first database at the telecommunications network; and
retrieving caller name information from a caller number lookup in an external database; and
translating to speech the caller name information.

10. The method of claim 9 further comprising the step of:
selecting, at the mobile phone, one of turning on and turning off a capability of the mobile phone to utilize audio information that is associated with the caller-ID information.

11. The method of claim 7 wherein the audio information that is associated with the caller-ID information is determined by input from the mobile phone.

12. The method of claim 7 wherein operation of the mobile phone is a hands-free operation.

13. The method of claim 7 wherein the telecommunications system also rings the mobile phone when the audio information that is associated with the caller-ID information is transmitted to the mobile phone.

14. A system in a telecommunications network for verbally announcing a caller identity on a mobile phone, said system comprising:
a determination module at telecommunications network, that for a given call, selects one of at least two sources of audio information, and outputs a selected audio information for the caller-ID information; and
an audio module in the mobile phone that plays the selected audio information at the mobile phone.

15. The system of claim 14, wherein
a first database operatively connected to the telecommunications network and having at least one unique audio information that is respectively associated with at least one caller-ID information, the first database being external to the telecommunications network; and
a second database at the telecommunications network having at least one telephone number to name mapping for translation from text to speech that is respectively associated with at least one further caller-ID information.

16. The system of claim 14, wherein the mobile phone further comprises an activation module that activates and deactivates a capability of the mobile phone to utilize audio information that is associated with the caller-ID information.

17. The system of claim 14 wherein the audio information that is associated with the caller-ID information is determined by input from the mobile phone.

18. The system of claim 14 wherein operation of the mobile phone is a hands-free operation.
